(19) United States
(12) Patent Application Publication
(10) Pub. No.: US 2010/0308776 A1
(43) Pub. Date: Dec. 9, 2010

(54) BATTERY CHARGER

(75) Inventors: Dezhong Yang, Nanjing (CN); Nanfei Wu, Nanjing (CN)

Correspondence Address: GREENBERG TRAURIG, LLP, 77 WEST WACKER DRIVE, SUITE 3100, CHICAGO, IL, 60601-1732, US

(73) Assignee: CHERVON LIMITED, Wanchai (HK)

(21) Appl. No.: 12/789,698

(22) Filed: May 28, 2010

(30) Foreign Application Priority Data
Jun. 5, 2009 (CN) 200920046370.3

(51) Int. Cl. H02J 7/00

(52) U.S. Cl. 320/163

(57) ABSTRACT

A charger for lithium battery pack has a voltage input terminal, a current control module and a voltage output terminal including a voltage-rising module and a voltage-detecting module connected with the voltage-rising module and the voltage input terminal.

### RELATED APPLICATION

This application claims the benefit of CN Application No. 200920046370.3, filed on Jun. 5, 2009, which application is incorporated herein by reference in its entirety.

### FIELD OF THE INVENTION

The present invention relates to a charger, and more particularly, to a charger for charging lithium battery pack.

### BACKGROUND

The lithium battery pack is widely used in direct-current tools for the advantages of portability and large energy capacity. A charger for charging the lithium battery pack is usually a voltage-drop charger. Because an input voltage of the charger is higher than a maximum voltage of the lithium battery pack, and it is determined by the circuit structure of the voltage-dropping charger that the input voltage will be directly applied on the lithium battery pack when a switch of the voltage-dropping module is broken down or short-circuited, at this moment, the lithium battery pack may endure a charging voltage higher than a nominal voltage of the battery pack such that there is a possibility of overcharging the lithium battery pack.

### SUMMARY

The object of the present utility model is to provide a charger which is voltage-rising type and is a lithium battery pack charger able to provide protection of input voltage detecting.

To achieve the above objects, the lithium battery pack charger according to the present invention comprises a voltage input terminal, a current control module and a voltage output terminal, the charger further comprises a voltage-rising module and a voltage-detecting module connected with the voltage-rising module and the voltage input terminal.

The voltage-rising module includes a power switch connected with an energy-storage inductor, a diode and a voltage-rising control unit.

The voltage-detecting module includes a voltage-detecting apparatus and an electronic switch.

The charger of the present invention can prevent the lithium battery pack from being overcharged during charging.

### BRIEF DESCRIPTION OF THE DRAWINGS

FIG. 1 is a schematic view of circuit module of the charger of a preferred embodiment according to the present invention.

### DETAILED DESCRIPTION

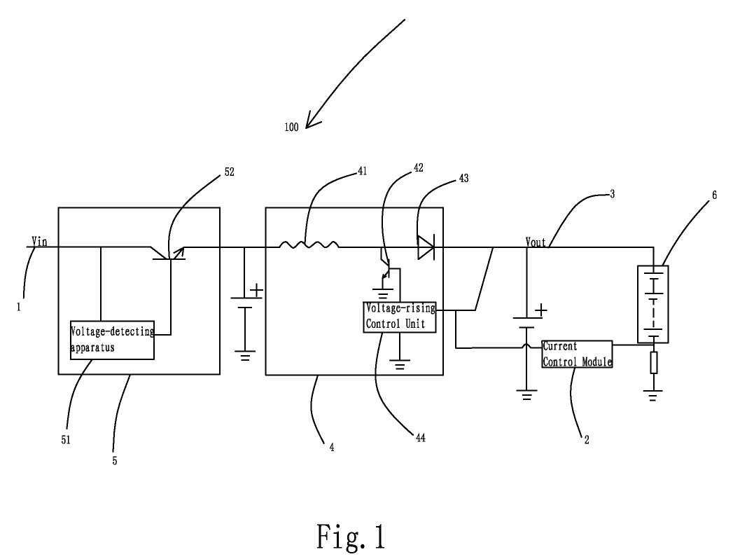

As shown in FIG. 1, a circuit module 100 of a charger according to the present invention comprises a voltage input terminal 1, a current control module 2 and a voltage output terminal 3. The charger can charge a lithium battery pile 6 of a lithium battery pack. The charger further comprises a voltage-rising module 4 and a voltage-detecting module 5.

The voltage-rising module 4 comprises a power switch 42 connected with an energy-storage inductor 41, a diode 43, and a voltage-rising control unit 44. The voltage-detecting module 5 comprises a voltage-detecting apparatus 51 and an electronic switch 52.

When the power switch 42 turns on, the input voltage forms a closed circuit through the energy-storage inductor 41 and the turning-on power switch 42 and, meanwhile, the energy-storage inductor 41 stores the energy. The input voltage and the induced voltage of the energy-storage inductor are output to the output terminal 3 through a diode 43 when the power switch 42 turns off.

When the outside linking voltage of the input terminal 1 is normal, the voltage-detecting module 5 turns on the electronic switch 52 and supplies the voltage to the input terminal of the voltage-rising module 4, i.e. the anode of the capacitor C1, then the voltage-rising control unit 44 starts to work, which controls the voltage required by the voltage output terminal 3 by controlling the turn-on or turn-off of the power switch 42. If the power switch 42 of the voltage-rising module 4 is broken down or short-circuited, the input voltage of the input terminal 1 will be directly grounded through the energy-storage inductor, the output voltage of the output terminal 3 of the charger will be almost zero and the lithium battery pile 6 will not withstand the charging voltage.

When the outside linking voltage of the input terminal 1 is abnormal, and the voltage-detecting apparatus 51 of the voltage-detecting model 5 detects that the outside linking voltage is higher than the set value (for instance, when the outer voltage source is improperly used or damaged), the voltage-detecting module 51 turns off the electronic switch 52 of the pathway and then cuts off the voltage, so that the input voltage of the voltage-rising module 4 becomes zero and the voltage-rising module 4 shuts down, and the charger almost has no output voltage, which effectively prevents such risk as the lithium battery pile 6 being overcharged under high voltage.

In this embodiment, no matter the outside linking voltage of the input terminal 1 or if the case of the power switch 42 becoming abnormal, the charger is able to effectively limit the output voltage in order to avoid the possible risk created in the lithium battery pile 6 under high voltage.

The present utility model is not limited to the specific solution disclosed in the above text and the accompanying drawings, and may further include the other embodiments. It needs to be mentioned that, the above embodiment is nonrestrictive. Except for this embodiment, the variations implemented by the skilled person in the art according to the common knowledge will fall into the protection scope of the present utility model.

What is claimed is:

1. A charger for charging a lithium battery pack, comprising: a voltage input terminal, a current control module, and a voltage output terminal, wherein the charger further comprises a voltage-rising module and a voltage-detecting module connected with the voltage-rising module and the voltage input terminal.

2. The charger according to claim 1, wherein the voltage-rising module includes a power switch connected with at least one energy-storage inductor and one voltage-rising control unit.

3. The charger according to claim 2, wherein the voltage-rising module further includes a diode connected with the power switch.

4. The charger according to claim 1, wherein the voltage-detecting module includes at least one voltage-detecting apparatus and one electronic switch.

5. The charger according to claim 1, wherein the charger charges a battery pack of a direct-current electric tool.
